(19) United States
(12) Patent Application Publication
(10) Pub. No.: US 2015/0136789 A1
(43) Pub. Date: May 21, 2015

(54) PRESSURE VESSEL WITH COMPOSITE BOSS

(71) Applicants: Francesco Nettis, London (GB); Brian Spencer, Sacramento, CA (US); Zachary Spencer, Sacramento, CA (US)

(72) Inventors: Francesco Nettis, London (GB); Brian Spencer, Sacramento, CA (US); Zachary Spencer, Sacramento, CA (US)

(21) Appl. No.: 14/362,477

(22) PCT Filed: Dec. 5, 2011
(86) PCT No.: PCT/EP2011/071810

§ 371 Date: Jan. 8, 2015

(51) Int. Cl. F17C 5/02

(52) U.S. Cl. CPC F17C 5/02
USPC 220/560.04

(57) ABSTRACT

This invention relates to a one-piece composite boss for use with pressure vessel used to transport compressed fluids.

### FIELD

This invention relates to a composite boss for pressure vessels used for the containment and transport of compressed fluids.

### BACKGROUND

The detrimental effects of the burning of fossil fuels on the environment are becoming more and more of a concern and have spurred great interest in alternative energy sources. While progress is being made with solar, wind, nuclear, geothermal, and other energy sources, it is quite clear that the widespread availability of economical alternate energy sources, in particular for high energy use applications, remains an elusive target. In the meantime, fossil fuels are forecast to dominate the energy market for the foreseeable future. Among the fossil fuels, natural gas is the cleanest burning and therefore the clear choice for energy production. There is, therefore, a movement afoot to supplement or supplant, as much as possible, other fossil fuels such as coal and petroleum with natural gas as the world becomes more conscious of the environmental repercussions of burning fossil fuels. Unfortunately, much of world's natural gas deposits exist in remote, difficult to access regions of the planet. Terrain and geopolitical factors render it extremely difficult to reliably and economically extract the natural gas from these regions. The use of pipelines and overland transport has been evaluated, in some instances attempted, and found to be uneconomical. Interestingly, a large portion of the earth's remote natural gas reserves is located in relatively close proximity to the oceans and other bodies of water having ready access to the oceans. Thus, marine transport of natural gas from the remote locations would appear to be an obvious solution. The problem with marine transport of natural gas lies largely in the economics. Ocean-going vessels can carry just so much laden weight and the cost of shipping by sea reflects this fact, the cost being calculated on the total weight being shipped, that is, the weight of the product plus the weight of the container vessel in which the product is being shipped. If the net weight of the product is low compared to the tare weight of the shipping container, the cost of shipping per unit mass of product becomes prohibitive. This is particularly true of the transport of compressed fluids, which conventionally are transported in steel cylinders that are extremely heavy compared to weight of contained fluid. This problem has been ameliorated somewhat by the advent of Type III and Type IV pressure vessels. Type III pressure vessels are comprised of a relatively thin metal liner that is wound with a filamentous composite wrap, which results in a vessel with the strength of a steel vessel at a substantial saving in overall vessel weight. Type IV pressure vessels comprise a polymeric liner that is likewise wrapped with a composite filamentous material. Type IV pressure vessels are the lightest of all the presently approved pressure vessels. The use of Type III and Type IV vessels coupled with the trend to make these vessels very large—cylindrical vessels 18 meters in length and 2.5-3.0 meters in diameter are currently being fabricated and vessel 30 or more meters in length and 6 or more meters in diameter are contemplated—has resulted in a major step forward in optimizing the economics of ocean transport of compressed fluids.

All pressure vessels require at least one end fitting, called a “boss,” by which the vessel is connected to external paraphernalia for loading fluids into and unloading fluids out of the vessel. Bosses in current use are made of metals such as stainless steel, nickel alloys, aluminum and the like. Unfortunately, these bosses, in particular with regard to the larger pressure vessels, are extremely heavy and have been estimated to comprise as much as 70% of the weight of a Type III or Type IV pressure vessel. Further, large metal bosses are difficult to manufacture and tend to be expensive, often costing $100,000 or more. These factors have a huge negative effect on the economics, and thereby the viability, of ocean transport of compressed fluids.

What is needed is lighter, cheaper bosses for pressure vessels, in particular Type III and Type IV pressure vessels where their impact would be most beneficial, for the transport of compressed fluids. The instant invention provides such bosses.

### SUMMARY

Thus, in one aspect, this invention relates to a pressure vessel comprising a one-piece composite boss.
In an aspect of this invention, the one-piece composite boss comprises:
a hollow elongate cylinder having a proximal end, a distal end, an outer surface and an inner surface, the inner surface defining the diameter of the hollow portion of the elongate cylinder.
A portion of the outer surface of the cylinder can be is contiguous with a thickness of a wall of the pressure vessel that defines a circular opening in the pressure vessel.
The proximal end of the cylinder can terminate exterior to the pressure vessel in a proximal end surface.
The proximal end surface can comprise a plurality of peripherally disposed threaded holes.
The distal end of the cylinder can terminate in a flange having a flange surface that is contiguous with an inner surface of the pressure vessel, a flange diameter that is larger than the diameter of the circular opening in the pressure vessel and a flange thickness at the point where the flange surface meets the diameter of the circular opening, that is sufficient to withstand a pressure exerted by a compressed fluid contained in the pressure vessel.

In an aspect of this invention, surfaces of the boss that would otherwise come in contact with the compressed fluid are separated from the compressed fluid by a layer of material that is substantially impenetrable by the compressed fluid at the operating pressure of the pressure vessel.

In an aspect of this invention, the layer of material is also substantially inert to the compressed fluid.

In an aspect of this invention, the layer of material comprises a metal, a ceramic or a polymer.

In an aspect of this invention, the shape of the pressure vessel comprises a sphere, an oblate spheroid, a torus or an elongate hollow cylinder with one or two domed end sections.

In an aspect of this invention, the pressure vessel is made entirely of a metal of sufficient thickness to withstand the pressure exerted by the compressed fluid contained therein.

In an aspect of this invention, the hollow cylinder with one or two domed end section comprises a thin metal liner that is hoop-wrapped with a polymeric composite and the one or two domed end sections comprise a metal, which may be the same as or different than the metal of the cylinder liner, at a sufficient thickness to withstand the pressure exerted by the compressed fluid contained in the pressure vessel.

In an aspect of this invention, the hollow cylindrical and the one or two domed end sections comprise a thin metal liner, wherein:
the hollow cylinder is hoop-wrapped with a polymeric composite and the cylinder and domed end sections are isotensoidally-wrapped with a polymeric composite, which may be the same as, or different than the polymeric composite of the hoop wrap.

In an aspect of this invention, the hollow cylindrical and the one or two domed end sections comprise a polymeric liner that is hoop-wrapped, isotensoidally wrapped or a combination of hoop—and isotensoidally—wrapped with a polymeric composite.

In an aspect of this invention, the pressure vessel further comprises a shear ply positioned between surfaces of the boss and surfaces of the polymeric composite wrap at locations where boss surfaces would otherwise be in direct contact with wrap surfaces.

In an aspect of this invention, the diameter of the flange extends at least to an inflection point in the one or two domed end section contours.

In an aspect of this invention, the polymeric composite comprises a thermoset polymer matrix.

In an aspect of this invention, the thermoset polymer matrix is selected from the group consisting of epoxy resins, polyester resins, vinyl ester resins, polyimide resins, dicyclopentadiene resins and combinations thereof.

In an aspect of this invention, the thermoset polymer matrix is formed from a prepolymer formulation that comprises dicyclopentadiene, which is at least 92% pure.

In an aspect of this invention, the polymeric composite comprises a fibrous material.

In an aspect of this invention, the fibrous material is selected from the group consisting of metal fibers, ceramic fibers, natural fibers, glass fibers, carbon fibers, aramid fibers, ultra-high molecular weight polyethylene fibers and combinations thereof.

In an aspect of this invention, the fibrous material is selected from the group consisting of glass fibers and carbon fibers.

In an aspect of this invention, the pressure vessel further comprises metallic inserts having a threaded outer surface that mates with the threaded holes in the proximal end surface of the boss and a threaded inner surface sized to mate with threads of an external pipe coupling device.

In an aspect of this invention, the compressed fluid comprises compressed natural gas.

In an aspect of this invention, the compressed natural gas comprises compressed raw natural gas.

### DETAILED DESCRIPTION

### Brief Description of the Figures

These figures are provided for illustrative purposes only and are not intended nor should they be construed as limiting this invention in any manner whatsoever.

FIG. 1 shows isometric projections of various types of pressure vessels. The vessel are shown with apertures where composite bosses of this invention would be inserted.

FIG. 1A shows a spherical pressure vessel.

FIG. 1B shows and oblate spheroid, sometimes referred to as a “near sphere,” pressure vessel.

FIG. 1C shows a toroidal pressure vessel

FIG. 1D shows a pressure vessel with a cylindrical center section and one domed end section

FIG. 1E shows a pressure vessel with a cylindrical center section and two domed end sections.

FIG. 2 is a schematic representation of a pressure vessel with a cylindrical center section and two domed end sections.

FIG. 3 shows a composite boss of this invention.

FIG. 4 shows a composite boss of this invention coupled to a pressure vessel liner.

FIG. 5 shows a pressure vessel liner wrapped with a filamentous composite illustrating the creation of an inflection point.

FIG. 6 shows a pressure vessel with a shear ply inserted between the composite over-wrap and the boss where surfaces of the two constructs would otherwise be in direct contact.

### DISCUSSION

It is understood that, with regard to this description and the appended claims, reference to any aspect of this invention made in the singular includes the plural and vice versa unless it is expressly stated or unambiguously clear from the context that such is not intended. For instance, reference to a “polar opening” is to be construed as relating to a single polar opening or to two polar openings. Likewise, reference to “domes” is to be construed as referring to one dome as well as two domes.

As used herein, any term of approximation such as, without limitation, near, about, approximately, substantially, essentially and the like, mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise.

The terms “proximal” and “distal” simply refer to the opposite ends of a construct and are used as a method of orienting an object with relation to another object such as the orientation of a boss of this invention with a vessel liner. In general, which end is designated as proximal and which as distal is purely arbitrary unless the context unambiguously expresses otherwise.

As used herein, “contiguous” refers to two surfaces that are adjacent and that are in direct contact or that would be in direct contact were it not for an intervening layer of another material such as, without limitation, a shear ply.

As used herein, “impermeable” or “impervious” refers to the property of a substance that renders it substantially impossible for a fluid to penetrate to any significant degree into a surface formed of the first substance.

As used herein, “inert” refers to the property of a substance that renders a surface formed of the substance chemically unreactive toward any components of a fluid that may be contacted with the surface.

As used herein, the use of “preferred,” “preferably,” or “more preferred,” and the like refers to preferences as they existed at the time of filing of this patent application.

As used herein, a “fluid” refers to a gas, a liquid or a mixture of gas and liquid. For example, without limitation, natural gas as it is extracted from the ground and transported to a processing center is often a mixture of the gas with liquid contaminants. Such mixture would constitute a fluid for the purposes of this invention.

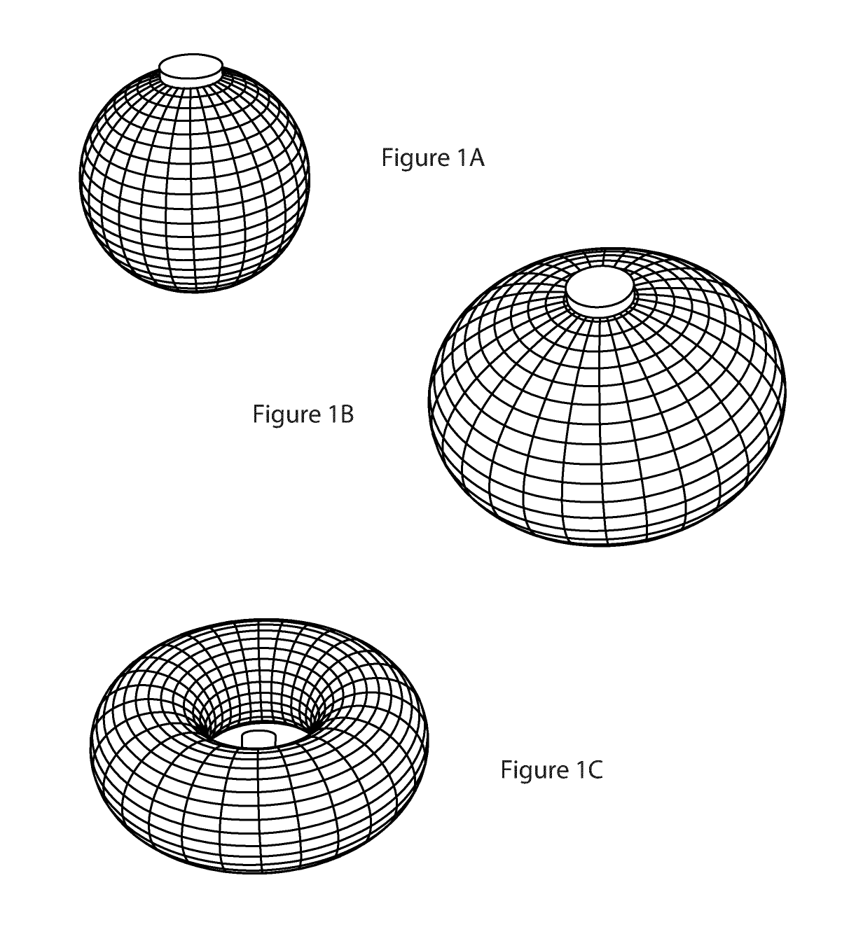

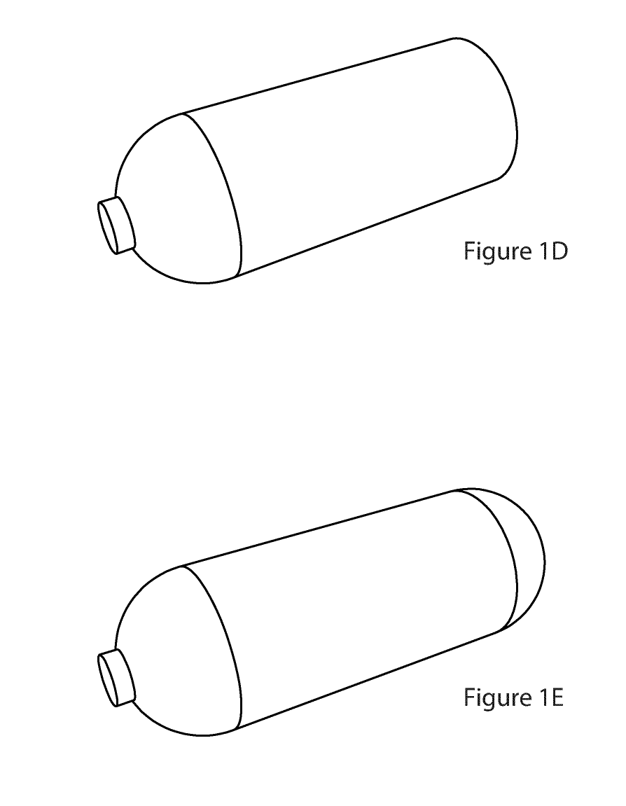

As used herein, a “wrap” or “over-wrap” refers to the winding of a filamentous material around a construct, which may be, without limitation, cylindrical, geodesic, toroidal, spherical, oblate spheroidal, etc. as illustrated in FIG. 1. The filamentous material may be wound around the construct in a dry state and left as such or it may subsequently be impregnated with and embedded in polymeric matrix. Alternatively, the filamentous material may be impregnated with a polymeric matrix prior to being wound onto a construct in which case it also becomes embedded in excess matrix material.

As used herein, a “polymeric composite” has the meaning that would be ascribed to it by those skilled in the art. In brief, it refers to a fibrous or filamentous material that is impregnated with, enveloped by or both impregnated with and enveloped by a polymer matrix material.

As used herein, a “boss” likewise refers to a device as such would be understood by those skilled in the art. In brief, a “boss” is a device used to interconnect a pressure vessel with external piping through which the pressure vessel is filled or emptied with a fluid.

Pressure vessels for the transport of compressed fluids, such as compressed natural gas, CNG, presently constitute four regulatory agency approved classes, all of which are cylindrical with one or two domed ends:

Class I. Comprises an all metal, usually aluminum or steel, construct. This type of vessel is inexpensive but is very heavy in relation to the other classes of vessels. Although Type I pressure vessels currently comprise a large portion of the containers used to ship compressed fluids by sea, their use in marine transport incurs very tight economic constraints.

Class II. Comprises a thinner metal cylindrical center section with standard thickness metal end domes in which only the cylindrical portion is reinforced with a composite wrap. The composite wrap generally constitutes glass or carbon filament impregnated with a polymer matrix. The composite is usually “hoop wrapped” around the middle of the vessel. The domes at one or both ends of the vessel are not composite wrapped. In Class II pressure vessels, the metal liner carries about 50% of the stress and the composite carries about 50% of the stress resulting from the internal pressure of the contained compressed fluid. Class II vessels are lighter than Class I vessels but are more expensive.

Class III. Comprises a thin metal liner for the entire structure wherein the liner is reinforced with a filamentous composite wrap around entire vessel. The stress in Type III vessels is shifted virtually entirely to the filamentous material of the composite wrap; the liner need only withstand a small portion of the stress. Type III vessels are much lighter than type I or II vessels but are substantially more expensive.

Class IV. Comprises a polymeric essentially gas-tight liner that is fully wrapped with a filamentous composite. The composite wrap provides the entire strength of the vessel. Type IV vessels are by far the lightest of the four approved classes of pressure vessels but are also the most expensive.

A single-piece composite boss of this invention will be beneficially used with any type of pressure vessel. It will, for instance, dramatically reduce the weight of even a Type I or a Type II pressure vessel and such application is within the scope of this invention.

Perhaps most beneficial, however, will be the use of a boss of this invention with either a Type III or a Type IV pressure vessel where its use will even more dramatically reduce the weight of the vessel resulting in a substantial increase in the contained compressed fluid to pressure vessel tare weight ratio and concomitant increase in the value of the contained fluid per unit weight of the vessel. Of course, use of a single-piece composite boss of this invention with pressure vessels of yet undefined types is within the scope of this invention.

As noted above, Type II, III and IV pressure vessel require a composite wrap to give them the necessary strength to withstand the pressure exerted by a compressed fluid contained in the vessel. For a Type II pressure vessel, the wrap is relatively straight-forward and is referred by those skilled in the art as “hoop-wrapping,” which is described elsewhere herein and which is very well-known to those skilled in that art. On the other hand, for Type III and Type IV pressure vessels, to produce a vessel that has the requisite strength it is necessary to wrap the vessel, sometimes in addition to hoop-wrapping, sometimes in lieu of hoop-wrapping, in a manner called “isostensoidal-wrapping,” which is likewise known in the art and is also described elsewhere herein.

When an entire vessel is wrapped with a composite, the underlying metal or polymeric structure is conventionally referred to as a “liner,” which provides the surface on which the composite wrap is wound and which is the surface with which the contained compressed fluid is in direct contact.

For the purpose of this disclosure, only a pressure vessel liner that forms a cylindrical center section with two domed end sections (for the sake of brevity, such vessel will henceforth be referred to simply as a “cylindrical pressure vessel”) and a boss of this invention fitted to a polar opening in one of the domed end sections is described in detail. A boss of this invention would, however, be equally applicable to a spherical, oblate spheroid (near sphere) or toroidal pressure vessel.

Once the boss is fitted to any of these alternate vessel structures, standard techniques for completing the fabrication of the pressure vessel by applying a composite wrap, if necessary, is well-known to those skilled in the art.

Once the cylindrical pressure vessel liner/boss assembly is in hand, while it is hardly a trivial exercise, it is a well-established procedure to design and apply to the liner, including the end domes, a composite comprising a filamentous material and a polymeric matrix, the end result being a completely composite-wrapped pressure vessel. In brief, for a given diameter cylindrical section of a pressure vessel liner, a given polar opening diameter, a given dome shape and a given filament width, a winding pattern can readily be determined using known algorithms including, without limitation, netting analysis, finite element analysis and combinations thereof. Using these mathematical formulae permits the design of a winding pattern that results is an isotensoid wrap of the vessel.

The term “isotensoid” refers to the property of the fully wound vessel in which each filament of the wrap experiences a constant pressure at all points in its path. This is currently considered to be the optimal design for a composite wrapped pressure vessel because, in this configuration, virtually the entire stress imposed on the vessel by a compressed fluid is assumed by the filaments of the composite with very little of the stress being assumed by the polymeric matrix or the liner.

Dome shapes may vary and include, but are not limited to, 2:1 ellipsoidal, 3:1 ellipsoidal and geodesic. The characteristics “2:1” and “3:1” refer to the ratio of the major axis to the minor axis of an ellipse. Presently preferred is a geodesic dome shape since it constitutes a surface of revolution that is amenable to numerical solution for each polar opening diameter, each cylindrical section diameter and each filament width. This numerical solution in turn permits the progressive plotting of the curvature of the dome from the diameter of the pressure vessel toward the polar opening.

Knowledge of the curvature then permits the design and application of a maximum strength, i.e., isotensoid, filament wrap to the vessel using the algorithms mentioned above.

Such pressure vessels exhibit the optimal combination of highest pressure loading at the lightest overall weight.

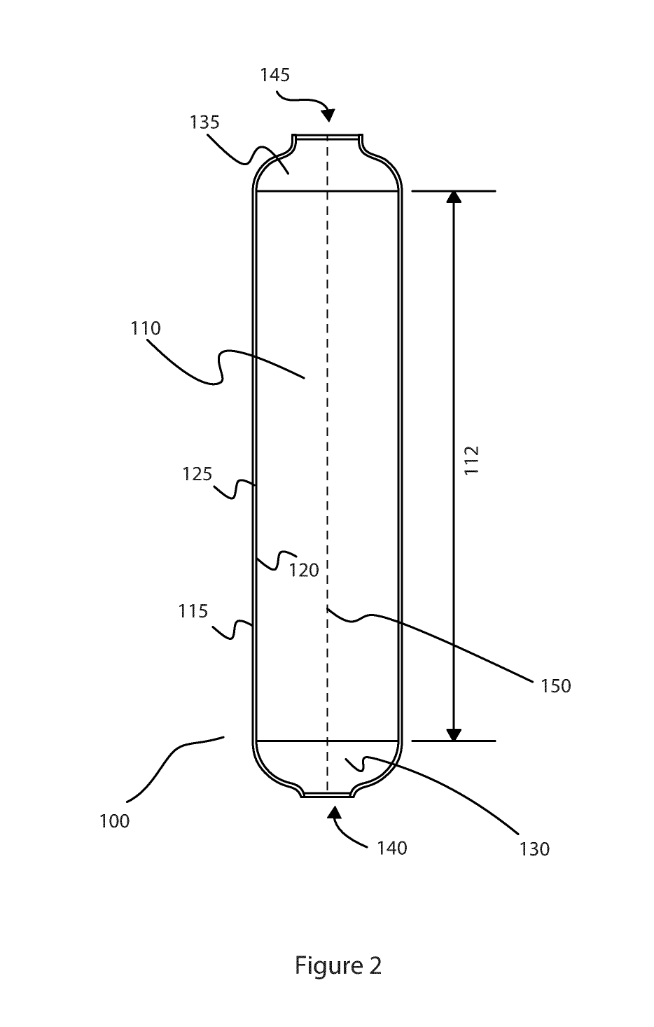

An isometric projection of a cylindrical pressure vessel liner is shown in FIG. 1E. Pressure vessel liner 1 is comprised of cylindrical portion 10, domes 20 and 30 and polar opening 40 in dome 20. Dome 30 may or may not have a polar opening similar to that shown in dome 20. A “polar opening” refers to a hole in the dome, usually circular in shape, the perimeter of which is radially equidistant from centerline 150 of vessel 1, as shown in FIG. 2, which is a schematic representation of a cylindrical pressure vessel liner with two polar openings, one at each end. The polar openings are formed as necks that are blended with the domes such that the domes form shoulders for the necks. One of the necks can be larger than the other, or they can be the same size. As illustrated, the top neck is usually the wider neck since it is typically for inspection purposes, whereas the bottom neck is usually for loading and offloading fluid.

A composite boss of this invention is fitted to the polar opening or openings, the liner would be wound with a filamentous composite and then additional hardware, well-known to those in the art, would be coupled to the boss, for the delivery to and removal from the vessel of a compressed fluid.

A more detailed schematic of a pressure vessel liner is shown in FIG. 2. As mentioned previously, the composite overwrap, while constituting relatively sophisticated design mathematics and implementation machinery, is well-known to those skilled in the pressure vessel design and fabrication art and any of these known techniques can be applied to a pressure vessel liner comprising a composite boss of this invention. Thus, except where aspects of composite-wrapping are relevant to elements of this invention, in which case they will be fully discussed, the design and implementation of composite vessel wraps will not be further discussed.

Pressure vessel liner 100 shown in FIG. 2 is comprised of cylindrical center section 110 having length 112, outer surface 115, inner surface 120, thickness 125, domes 130 and 135 and polar openings 140 and 145.

As mentioned previously, it is possible and is within the scope of this invention that a pressure vessel of this invention may comprise a polar opening in only one of domes 130 and 135.

The domes as shown are rounded to blend from the cylinder, through the shoulders and up to the neck. They can also assume other curved shapes, including generally hemi-spherical shapes. With such hemi-spherical shapes in particular, it is noted that, as the length 112 of cylindrical section 110 approaches zero, the result is a substantially spherical or oblate spheroidal pressure vessel. This merely reinforces the previous statement that the composite boss of this invention is equally suited to a spherical or oblate spheroidal pressure vessel as it is to a cylindrical pressure vessel.

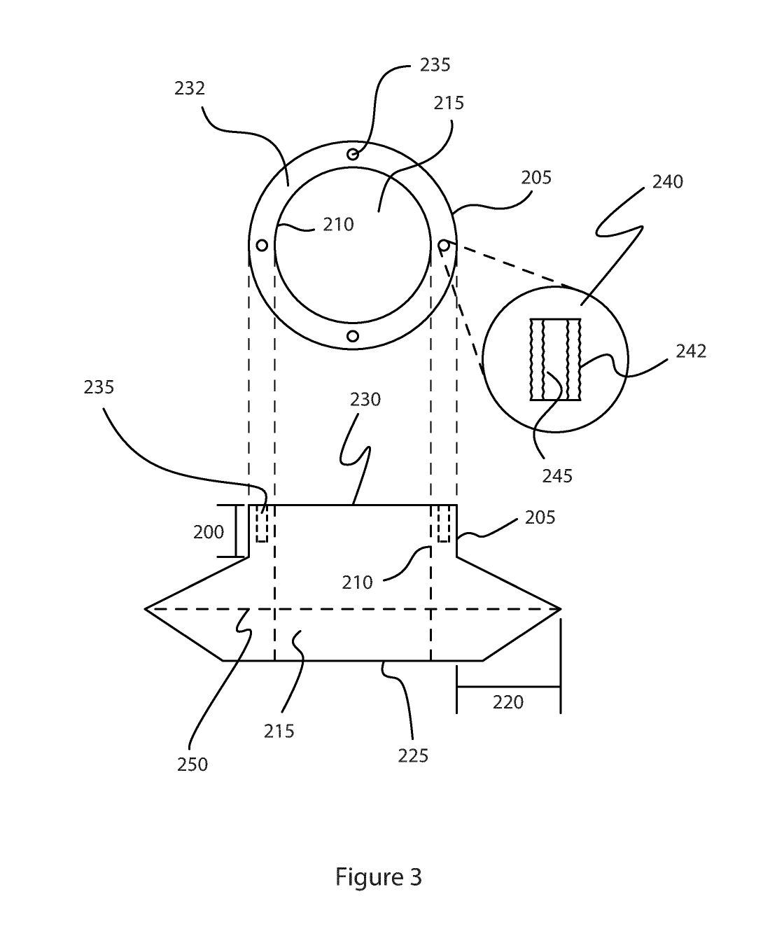

FIG. 3 shows a boss comprising a single-piece construct of this invention, shaped to fit into a polar opening of a generally hemi-spherical dome. The boss comprises tubular center section 200 having outer surface 205, inner surface 210, through-hole 215 and flange, sometimes referred to in the art as a “wing”, 220.

For the purposes of description, the flange end of the boss will be considered to be its distal end and the other end naturally, will be considered the proximal end.

Threaded holes 235 are radially disposed around proximal end surface 230. These threaded holes may be used directly to connect the boss to a flange piece that in turn is used to couple the vessel to an external line for loading and unloading the vessel.

In a presently preferred alternative, threaded holes 235 form a mating surface with a diameter that is larger than that required for use with the intended fasteners. Into these oversize holes metallic inserts 240 with exterior threads 242 are screwed. The inserts also comprise internal threads 245 that are sized correctly for coupling to whatever device is to be used to attach the pressure vessel to an external system for loading and unloading. Only four holes 235 are shown in the figure for the sake of simplicity and clarity. It is understood that substantially more holes, sometimes in excess of 20, may be evenly spaced around proximal surface 230.

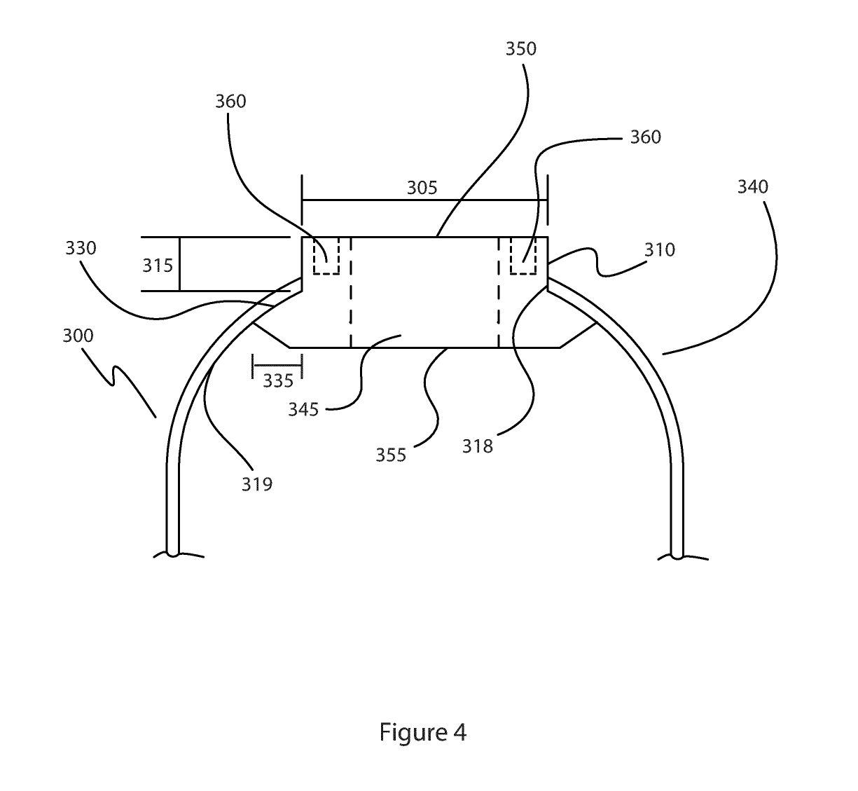

FIG. 4 shows an end section 300 of a pressure vessel liner with single piece composite boss 305 inserted into polar opening 307. As can be seen, a portion of outer surface 310 of tubular center section 315 is contiguous with surface 318 of liner 300 where polar opening 310 is defined by the thickness of the liner. Also, surface 330 of flange 335 is contiguous with inner surface 319 of liner 300 where surface 320 follows the contour of dome 340. Boss 305 has lumen 345 that extends from proximal end 350 to distal end 355. Boss 305 also has threaded holes 360 that, as discussed above, may be equipped with metallic threaded inserts as shown in FIG. 3.

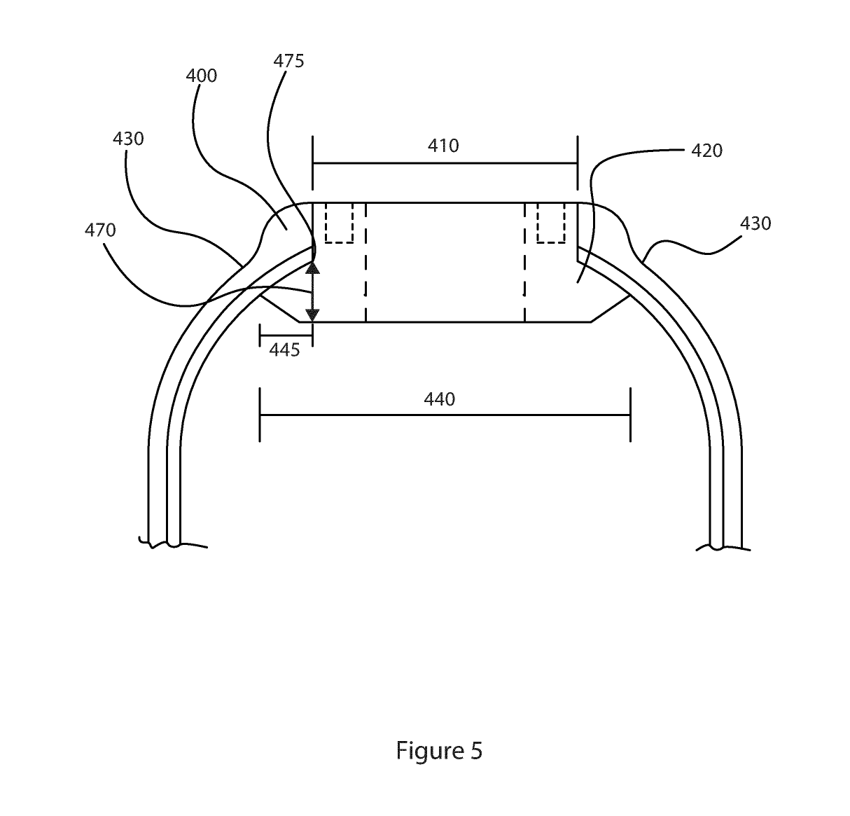

The dome of a pressure vessel liner may have a fairly broad range of contours. Most often, however, the contours comprise a 2:1 ellipsoidal, a 3:1 ellipsoidal or a geodesic shape. Most common and presently preferred is a geodesic contour. A geodesic contour is readily amendable to analysis using the previously mentioned netting and finite element analysis to determine the optimal filamentous winding pattern to create an isotensoidal wrap on all portions of the pressure vessel including domes containing polar openings. This is important to the design of the boss of this invention in that the diameter of the boss flange, while it of course must be greater than the diameter of the polar opening, performs a less obvious function. That is, once the above parameters are defined, the dimensions of the filament to be used are determined and the winding pattern established, the analytical mathematics dictate that the wound filament will tend to “stack up” at the circumference of the polar opening in order to maintain an isotensoid configuration. This results in an inflection point being created in the curvature of the wrapped dome. The inflection point is that point where the meridonial radius of curvature changes sign due to the stacking of the filament wrapping. This is shown in FIG. 5 where filamentous winding 400 is shown stacked up at the circumference of polar opening 410 where composite boss 420 in inserted into polar opening 410 and as the wrapping moves away from the polar opening, the winding spread out, that is, unstack, resulting in the curvature of the wrapped dome once again approximating the curvature of the dome itself.

The inflection point is indicated to occur generally in the region of 430 in FIG. 5 although the exact point, the point where the second derivative of the curve equation is zero, can be mathematically precisely determined.

In order to avoid a potentially catastrophic failure of the pressure vessel due to stresses at the inflection point, the diameter 440 of flange 445 is designed to at least reach the inflection point as shown in FIG. 5. In this manner, the effect of the inflection point is effectively eliminated, the stress that would occur at the inflection point being absorbed by flange 445.

It has been determined that, in particular with regard to metallic liners but also applicable to polymeric liners, rather than having flange 445 reach just to the inflection point of a wrapped dome, an even stronger overall vessel can be obtained if the diameter of the flange extends 2 to 5 liner thicknesses beyond the inflection point.

Another important factor to consider in the design of a composite boss of this invention is thickness 470 of the boss at shear point 475 in FIG. 5. Shear point 475 is that point where the flange meets the edge of the polar opening. Beyond the edge, that is, further toward the center line of the pressure vessel, the thickness of the boss alone must absorb virtually all of the stress imposed by the contained fluid because the composite wrap terminates at the polar opening. The exact thickness at the shear point will depend on the intended maximum operating pressure of the pressure vessel.

Once the maximum operating pressure and the mechanical properties of the composite of which the boss is fabricated are determined, relatively straight-forward application of mechanical engineering design calculations will permit the ready determination of an appropriate thickness of the boss at the shear point.

It is noted that, in this disclosure, no actual thicknesses or amounts of composite wrapping are expressly set forth. This is so because the thicknesses of the various sections of a pressure vessel and the amount of wrapping are predominantly dependent on the operating pressure of the vessel. The pressures are, of course, predetermined and exceeding them could result in catastrophic failure of the pressure vessel.

Once the maximum operating pressure of a vessel is established and the physical properties of the materials being used to fabricate the vessel, be they metal, polymer, ceramic, composite or other, are defined, it is a straight-forward application of engineering principles to determine the requisite thicknesses and amounts of wraps.

Since maximum operating pressures can vary substantially, it is unnecessary to expressly set forth any such specific dimensions for the purposes of this invention.

A composite boss of this invention comprises a polymeric matrix containing fibrous materials that confer additional strength on the composite. The polymeric matrix can be any polymer known or found to have properties consistent with use in a high pressure environment such as that found in a pressure vessel of this invention.

While thermoplastic polymers, thermoplastic elastomers, thermoset resins and combinations thereof can be used, presently preferred are thermoset polymers, which can exhibit significantly better mechanical properties, chemical resistance, thermal stability and overall durability than the other types of polymers.

A particular advantage of most thermoset plastics or resins is that their precursor monomers or prepolymers tend to have relatively low viscosities under ambient conditions of pressure and temperature and therefore can be introduced into or combined with fibers and filaments quite easily.

Another advantage is that thermoset polymers can usually be chemically cured isothermally, that is, at the same temperature at which they are combined with the fibers/filaments, which can be room temperature.

Suitable thermoset resins include, without limitation, epoxy resins, polyester resins, vinyl ester resins, polyimides, dicyclopentadiene resins and combinations thereof.

Presently preferred are dicyclopentadiene resins, in particular ROMP-synthesized cyclopentadiene resins.

It is also presently preferred that the dicyclopentadiene in the prepolymer formulation that will be used for the fabrication of the boss have a purity of at least 92%, preferably at present at least 98%.

As used herein, a “prepolymer formulation” refers to a blend of at least 92% pure dicyclopentadiene with one or more reactive ethylene monomer(s), a polymerization initiator or curing agent plus any other desirable additives prior to curing.

In general, any type of fibrous or filamentous material may be used to create the polymeric composites of this invention. Such materials include, without limitation, natural (silk, hemp, flax, etc.), metal, ceramic, basalt and synthetic polymer fibers and filaments.

Presently preferred materials include glass fibers, commonly known as fiberglass, carbon fibers, aramid fibers, which go mostly notably under the trade name Kevlar® and ultra-high molecular weight polyethylene, such as Spectra® (Honeywell Corporation) and Dyneeva® (Royal DSM N.V.).

The pressure vessel liner may comprise a single layer of material or multiple layers. For example, without limitation, the vessel liner shell may comprise a single metal layer such as, without limitation, stainless, steel, zinc, copper, tin, aluminum and combinations and alloys thereof, in which case the liner would be a Type III pressure vessel.

Alternatively the liner may comprise a single layer or multiple layers of polymer, wherein each layer may be the same as or different than each other layer, which would constitute a Type IV pressure vessel.

It may also or alternatively comprise a polymeric layer having on its inner surface, the surface in contact with the contained gas, a very thin layer of metal to assist with the impermeability, imperviousness or both impermeability and imperviousness, or impentetrability, of the vessel to a contained fluid. This would still comprise a Type IV pressure vessel since the metal layer would be too thin to constitute a structural feature of the liner.

Once the dimensions of the boss herein, in particular the diameter of the flange and its thickness at the shear point, have been determined using the disclosure herein, the boss itself can be fabricated using any method know in the art. For example, the boss can be milled from a solid piece of cured composite material. Or the boss can be molded using a flowable prepolymer formulation and techniques such as, without limitation, compression molding, reaction injection molded (RIM) or resin transfer molding (RTM), each of which is well-known to those skilled in the art and therefore requires no further elucidation.

Since a composite is generally to some extent permeable to fluids, in particular fluids under pressure, it may be desirable to apply to surfaces of a composite boss of this invention a layer of material that is impenetrable to the fluid that is contained in the pressure vessel.

It may concurrently be desirable to select a material that is also inert to the pressurized fluid, in particular if the fluid has caustic properties such as may be the case when raw natural gas, which may include substances such as carbon dioxide and hydrogen sulfide, which form acids when contacted with water.

The layer of material may constitute, without limitation, a metal cladding, a electroless or electrolytically deposited thin layer of metal, a layer of the same polymer used as the matrix polymer for the fabrication of the boss or the or another polymer that has the requisite properties of impenetrability and inertness.

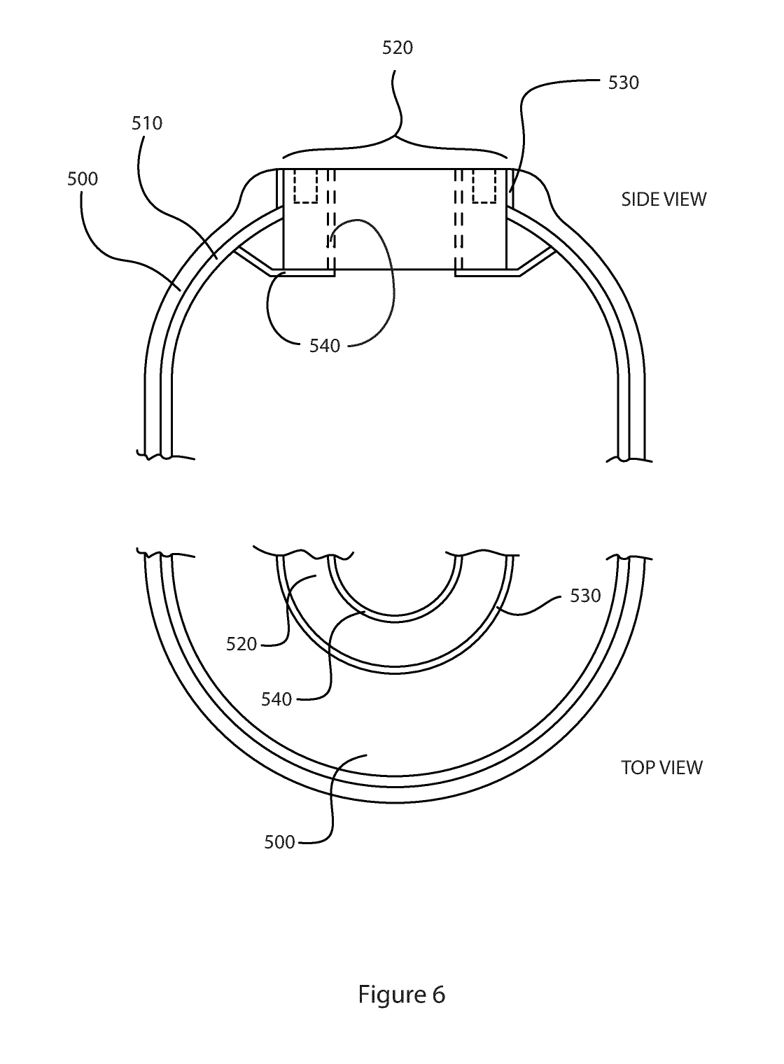

FIG. 6 shows a pressure vessel 500 with a composite boss 510 having an impenetrable/inert layer 540 on a surface 550 of the boss. The boss would otherwise contact the contained fluid in pressure vessel 500.

In general, those skilled in the art will be able to select an appropriate material to apply to the composite boss without undue experimentation and all such materials are within the scope of this invention.

When a composite boss of this invention and the composite overwrap of a pressure vessel are made of different materials, which expand and contract at different rates and to different degrees, it may be necessary to include a “shear ply” at the interface of the materials to absorb the stress produced when the materials move at different rates and to different degrees. A shear ply simply refers to the interface material.

A shear ply will generally constitute a thin layer of material with a shape dictated by the boss surface to composite overwrap surface interface that is to be separated.

A desirable interface material would have good elastomeric properties.

A desirable interface material would be able to withstand potentially substantial internal stress as one portion of it moves in response to movement of the composite boss material and another part of it moves in response to movement of the overwrap material.

Shear plies can generally comprise any of a vast array of rubbers and synthetic elastomers. The selection of a particular shear ply material will depend on several factors including the properties of the materials to be separated. Selection of an appropriate shear ply material would be well within the ability of those skilled in the art based on the disclosure herein.

In many cases, it may be possible to use the same material used as a shear ply to impart impenetrability and imperviousness to a composite boss of this invention.

Those skilled in the art will be able to select appropriate materials for each of these purposes without undue experimentation based on the disclosures herein.

An example of pressure vessel with composite boss 510 and composite overwrap 500 separated by shear ply is 530 is shown in FIG. 6.

A boss of this invention can be coupled with a vessel liner in several ways. If the vessel liner is polymeric, the complete liner, including the dome with polar opening, can be shaped on a mandrel. Once formed, the liner, while the polymer is still hot enough to be flexible or, if upon reheating it can again achieve a state of flexibility, can be mechanically expanded at the polar opening sufficiently to permit the flared flange at the distal end of the boss to pass through. With the boss in place, the polar opening liner can be allowed to return to its initial dimension and then the entire vessel liner can be cooled to set the boss in place. The result is shown in FIG. 4, where a portion of outer surface 318 of boss 305 can be seen to be contiguous with thickness 318 of liner 300 at the diameter of polar opening 305.

In this embodiment, the composite boss will be in contact with whatever material, gas and/or liquid, that is contained in the pressure vessel.

In another embodiment, the boss itself can be affixed to a mandrel where it becomes part of the template that is used to form the vessel liner. The vessel liner is then formed over the entire template including the boss. As above, the composite boss will be in direct contact with whatever is contained in the pressure vessel.

If a Type III vessel is contemplated, the boss may be fitted into the polar opening as the sheets of metal are being bent and joined to form the pressure vessel.

Other methods for coupling a composite boss of this invention with a liner may occur to those skilled in the art; all such methods are within the scope of this invention.

Once the vessel liner has been formed and the boss is in place using one of the techniques discussed above, the liner can be wound with a filamentous composite to produce the complete pressure vessel.

A fully-formed Type III or Type IV pressure vessel comprising a composite boss of this invention is within the scope hereof.

A pressure vessel comprising a boss of this invention can be used to contain and transport any type of fluid that is amenable to such transport and so long as the vessel or vessel liner, if present, be it metal, ceramic or polymer, is selected so as to be impermeable or impenetrable to the contained compressed fluid, and chemically inert thereto as well.

A presently preferred use of a composite boss-containing pressure vessel of this invention is for the containment and transport of natural gas, often referred to as “compressed natural gas” or simply “CNG.”

CNG may be contained and transported in the vessels of this invention both as a purified gas and as “raw gas.” Raw gas refers to natural gas as it comes, unprocessed, directly from the well. It contains, of course, the natural gas (methane) itself but also may contain liquids such as condensate, natural gasoline and liquefied petroleum gas. Water may also be present as may other gases, either in the gaseous state or dissolved in the water, such as nitrogen, carbon dioxide, hydrogen sulfide and helium. Some of these may be reactive in their own right or may be reactive when dissolved in water, such as carbon dioxide and hydrogen sulfide which produces an acid when dissolved in water.

The presently preferred liner polymer, dicyclopentadiene, has excellent properties with regard to chemical resistance to the above, and other materials that might constitute raw gas.

High density polyethylene also works well with raw gas.

Other liner materials that are impervious to raw gas components will readily be discernable based on the disclosures herein and pressure vessels having composite bosses of this invention together with any type of vessel or vessel liner composition are within the scope of this invention.

The pressure vessels described herein can carry a variety of gases, such as raw gas straight from a bore well, including raw natural gas, e.g. when compressed—raw CNG or RCNG, or H2, or CO2 or processed natural gas (methane), or raw or part processed natural gas, e.g. with CO2 allowances of up to 14% molar, H2S allowances of up to 1,000 ppm, or H2 and CO2 gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C2H6, C3H8, C4H10, C5H12, C6H14, C7H16, C8H18, C9+ hydrocarbons, CO2 and H2S, plus potentially toluene, diesel and octane in a liquid state, and other impurities/species.

The present invention has therefore been described above purely by way of example. Modifications in detail may be made to the invention within the scope of the claims appended hereto.

1. A pressure vessel comprising a one-piece composite boss.

2. The pressure vessel of claim 1, wherein the one-piece composite boss comprises:
a hollow elongate cylinder having a proximal end, a distal end, an outer surface and an inner surface, the inner surface defining the diameter of the hollow portion of the elongate cylinder, wherein:
a portion of the outer surface of the cylinder is contiguous with a thickness of a wall of the pressure vessel that defines a circular opening in the pressure vessel;
the proximal end of the cylinder terminates exterior to the pressure vessel in a proximal end surface wherein:
the proximal end surface comprises a plurality of peripherally disposed threaded holes, and
the distal end of the cylinder terminates in a flange having a flange surface that is contiguous with an inner surface of the pressure vessel, a flange diameter that is larger than the diameter of the circular opening in the pressure vessel and a flange thickness at the point where the flange surface meets the diameter of the circular opening, that is sufficient to withstand a pressure exerted by a compressed fluid contained in the pressure vessel.

3.-22. (canceled)

23. The pressure vessel of claim 2, wherein surfaces of the boss that would otherwise come in contact with the compressed fluid are separated from the compressed fluid by a layer of material that is substantially impenetrable by the compressed fluid at the operating pressure of the pressure vessel.

24. The pressure vessel of claim 23, wherein the layer of material comprises a metal, a ceramic or a polymer.

25. The pressure vessel of claim 24, wherein the layer of material is also substantially inert to the compressed fluid.

26. The pressure vessel of claim 2, wherein the shape of the pressure vessel comprises a sphere, an oblate spheroid, a torus or an elongate hollow cylinder with one or two domed end sections.

27. The pressure vessel of claim 26, wherein the pressure vessel is made entirely of a metal of sufficient thickness to withstand the pressure exerted by the compressed fluid contained therein.

28. The pressure vessel of claim 26, wherein the hollow cylinder with one or two domed end section comprises a thin metal liner that is hoop-wrapped with a polymeric composite and the one or two domed end sections comprise a metal, which may be the same as or different than the metal of the cylinder liner, at a sufficient thickness to withstand the pressure exerted by the compressed fluid contained in the pressure vessel.

29. The pressure vessel of claim 28, wherein the polymeric composite comprises a thermoset polymer matrix.

30. The pressure vessel of claim 29, wherein the thermoset polymer matrix is selected from the group consisting of epoxy resins, polyester resins, vinyl ester resins, polyimide resins, dicyclopentadiene resins and combinations thereof.

31. The pressure vessel of claim 30, wherein the thermoset polymer matrix is formed from a prepolymer formulation that comprises dicyclopentadiene, which is at least 92% pure.

32. The pressure vessel of claim 28, wherein the polymeric composite comprises a fibrous material.

33. The pressure vessel of claim 32, wherein the fibrous material is selected from the group consisting of metal fibers, ceramic fibers, natural fibers, glass fibers, carbon fibers, aramid fibers, ultra-high molecular weight polyethylene fibers and combinations thereof.

34. The pressure vessel of claim 33, wherein the fibrous material is selected from the group consisting of glass fibers and carbon fibers.

35. The pressure vessel of claim 26, wherein the hollow cylindrical and the one or two domed end sections comprise a thin metal liner, wherein:
the hollow cylinder is hoop-wrapped with a polymeric composite and the cylinder and domed end sections are isotensoidally-wrapped with a polymeric composite, which may be the same as, or different than the polymeric composite of the hoop wrap.

36. The pressure vessel of claim 26, wherein the hollow cylindrical and the one or two domed end sections comprise a polymeric liner that is hoop-wrapped, isotensoidally wrapped or a combination of hoop—and isotensoidally—wrapped with a polymeric composite.

37. The pressure vessel of claim 36, further comprising a shear ply positioned between surfaces of the boss and surfaces of the polymeric composite wrap at locations where boss surfaces would otherwise be in direct contact with wrap surfaces.

38. The pressure vessel of claim 26, wherein the diameter of the flange extends at least to an inflection point in the one or two domed end section contours.

39. The pressure vessel of claim 2, further comprising metallic inserts having a threaded outer surface that mates with threaded holes in the proximal end surface of the boss and a threaded inner surface sized to mate with threads of an external pipe coupling device.

40. The pressure vessel of claim 2, wherein the compressed fluid comprises compressed natural gas.

41. The pressure vessel of claim 40, wherein the compressed natural gas comprises compressed raw natural gas.

42. A ship comprising a pressure vessel according to claim 2.
